(19) United States
(12) Patent Application Publication
(10) Pub. No.: US 2007/0230712 A1
(43) Pub. Date: Oct. 4, 2007

(54) Telephony Device with Improved Noise Suppression

(75) Inventors: Harm Jan Willem Belt, Eindhoven (NL); Cornelis Pieter Janse, Eindhoven (NL); Ivo Leon Diane Marie Merks, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/574,603

(22) PCT Filed: Aug. 11, 2005
(86) PCT No.: PCT/IB05/52667

§ 371 Date: Mar. 2, 2007

(30) Foreign Application Priority Data
Sep. 7, 2004 (EP) 04300580.0

(51) Int. Cl. G10K 11/16

(52) U.S. Cl. 381/71.1

(57) ABSTRACT

The present invention relates to a telephony device comprising a near-mouth microphone (M1) for picking up an input acoustic signal including the speaker's voice signal (S1) and an unwanted noise signal (N1,D1), a far-mouth microphone (M2) for picking up an unwanted noise signal (N2,D2) in addition to the near-end speaker's voice signal (S2), said speaker's voice signal being at a lower level than the near-mouth microphone, and an orientation sensor for measuring an orientation indication of said mobile device. The telephony device further comprises an audio processing unit comprising an adaptive beamformer (BF) coupled to the near-mouth and far-mouth microphones, including spatial filters for spatially filtering the input signals (z1,z2) delivered by the two microphones, and a spectral post-processor (SPP) for post-processing the signal delivered by the beam-former so as to separate the desired voice signal from the unwanted noise signal so as to deliver the output signal (y).

### FIELD OF THE INVENTION

The present invention relates to a telephony device comprising at least one microphone for receiving an input acoustic signal including a desired voice signal and an unwanted noise signal, and an audio processing unit coupled to the at least one microphone for suppressing the unwanted noise from the acoustic signal.

It may be used, for example, in mobile phones or mobile headsets both for stationary and non-stationary noise suppression.

### BACKGROUND OF THE INVENTION

Noise suppression is an important feature in mobile telephony, both for the end-consumer and the network operator.

Noise suppression methods using a single-microphone have been developed based on the well-known spectral subtraction or minimum-mean-square error spectral amplitude estimation. By using a single-microphone noise suppression method, quasi-stationary noises can be suppressed without introducing speech distortion provided that the original signal-to-noise ratio is sufficiently large.

Better noise suppression can be achieved using multi-microphone solutions, where spatial selectivity is exploited. With multiple-microphone techniques one can achieve suppression of non-stationary noises such as, for example, babbling noises of people in the background.

The patent application US 2001/0016020 discloses a two-microphone noise suppression method based on three spectral subtractors. According to this noise suppression method, when a far-mouth microphone is used in conjunction with a near-mouth microphone, it is possible to handle non-stationary background noise as long as the noise spectrum can continuously be estimated from a single block of input samples. The far-mouth microphone, in addition to picking up the background noise, also picks up the speaker's voice, albeit at a lower level than the near-mouth microphone. To enhance the noise estimate, a spectral subtraction stage is used to suppress the speech in the far-mouth microphone signal. To be able to enhance the noise estimate, a rough speech estimate is formed with another spectral subtraction stage from the near-mouth signal. Finally, a third spectral subtraction function is used to enhance the near-mouth signal by suppressing the background noise using the enhanced background noise estimate.

### SUMMARY OF THE INVENTION

It is an object of the invention to propose a telephony device implementing an improved noise suppression method compared with the one of the prior art.

Indeed, the prior art method assumes a certain orientation of the handset against the ear of the user, such that a maximum amplitude difference of speech is obtained (i.e. the near-mouth microphone is closest to the mouth. With another orientation, the dual-microphone noise suppression method of the prior art may suppress rather than enhance the desired voice signal due to its spatial selectivity. Consequently, it may happen that an incorrect orientation of the telephony device held against the ear leads to unacceptable speech distortion.

To overcome this problem, the telephony device in accordance with the invention is characterized in that it comprises:
an orientation sensor for measuring an orientation indication of said telephony device,
at least one microphone for receiving an acoustic signal including a desired voice signal and an unwanted noise signal,
an audio processing unit coupled to the at least one microphone for suppressing the unwanted noise signal from the acoustic signal on the basis of the orientation indication.

The orientation sensor allows the orientation of the telephony device to be measured, and the audio processing unit utilizes said orientation indication so as to maximize the quality of the desired voice signal to be output. Thanks to the orientation indication, the audio processing unit is thus more robust against an incorrect orientation of the telephony device.

According to an embodiment of the invention, the telephony device includes a near-mouth microphone for receiving an acoustic signal including the desired voice signal and the unwanted noise signal and for delivering a first input signal, a far-mouth microphone for receiving an acoustic signal including the unwanted noise signal and the desired voice signal at a lower level than the near-mouth microphone and for delivering a second input signal; and the audio processing unit includes a beam-former coupled to the near-mouth and far-mouth microphones, comprising filters for spatially filtering the first and second input signals so as to deliver a noise reference signal and an improved near-mouth signal, and a spectral post-processor for performing spectral subtraction of the signals delivered by the beam-former so as to deliver an output signal. This dual-microphone technique is particularly efficient.

Preferably, the spectral post-processor is adapted to compute a spectral magnitude of the output signal from a product of a spectral magnitude of the improved near-mouth signal by an attenuation function, said attenuation function depending on a difference between the spectral magnitude of the improved near-mouth signal, a weighted spectral magnitude of an estimate of a stationary part of said improved near-mouth signal, and a weighted spectral magnitude of the noise reference signal, the value of said attenuation function being not smaller than a threshold. Beneficially, the threshold is the maximum between a fixed value and a sinus function of the orientation indication. The audio processing unit may also comprise means for detecting an in-beam activity based on a first comparison of a power of the first input signal with a power of the second input signal, and on a second comparison of a power of the improved near-mouth signal with a power of the noise reference signal, and means for updating filter coefficients if an in-beam activity has been detected.

According to another embodiment of the invention, the telephony device includes a microphone for receiving an acoustic signal including the desired voice signal and the unwanted noise signal and for delivering an input signal, and the audio processing unit includes a spectral post-processor which is adapted to compute a spectral magnitude of an output signal from a product of a spectral magnitude of the input signal by an attenuation function, said attenuation function depending on a difference between the spectral magnitude of the input signal and a weighted spectral magnitude of an estimate of a stationary part of said input signal, the value of said attenuation function being not smaller than a threshold. Such a single-microphone technique is particularly cost effective and simple to implement.

Still according to another embodiment of the invention, the telephony device comprises a loudspeaker for receiving an incoming signal and for delivering an echo signal, and means responsive to the incoming signal for performing echo cancellation, said means being coupled to the spectral post-processor.

The present invention also relates to a noise suppression method for a telephony device.

These and other aspects of the invention will be apparent from and will be elucidated with reference to the embodiments described hereinafter.

### BRIEF DESCRIPTION OF THE DRAWINGS

The present invention will now be described in more detail, by way of example, with reference to the accompanying drawings, wherein:

FIG. 1 is a block diagram of a telephony device in accordance with the invention, said device including two microphones,

FIGS. 2A and 2B shows a dual-microphone headset with an integrated orientation sensor,

FIGS. 3A and 3B shows a dual-microphone mobile phone with an integrated orientation sensor,

FIG. 4 is a block diagram of a dual-microphone mobile phone in accordance with the invention, said phone being adapted to perform echo cancellation,

FIG. 5 is a block diagram of a telephony device in accordance with the invention, said device including a single microphone, and

FIG. 6 is a block diagram of a single-microphone mobile phone in accordance with the invention, said phone being adapted to perform echo cancellation

### DETAILED DESCRIPTION OF THE INVENTION

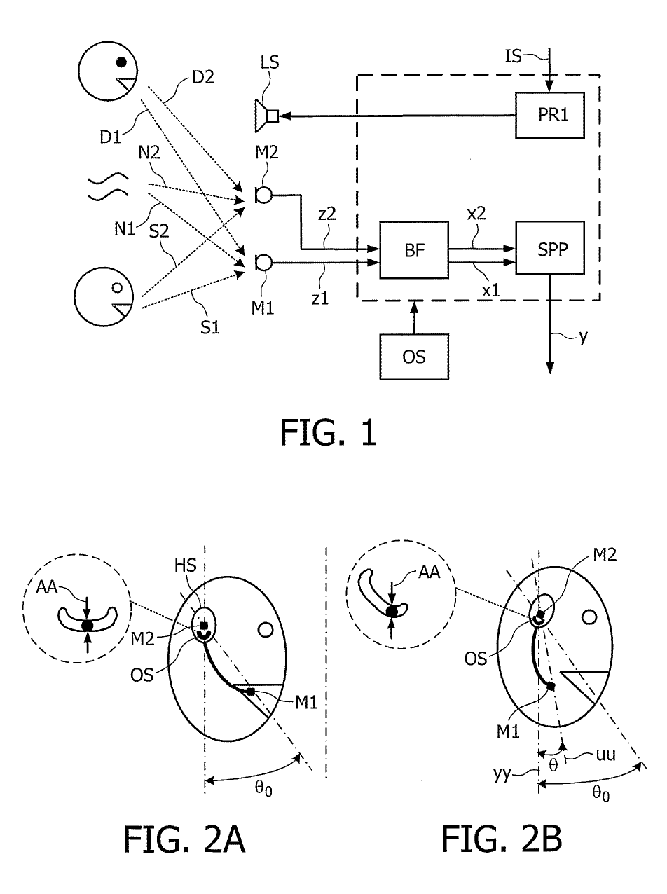

Referring to FIG. 1, a telephony device in accordance with an embodiment of the present invention is disclosed. Said telephony device is, for example, a mobile phone. It comprises:
a loud speaker LS for transmitting an output acoustic signal derived from an incoming signal IS coming from a far-end user via a communication network,
a near-mouth microphone M1 for picking up an input acoustic signal including the speaker's voice signal S1 but also an unwanted noise signal N1 and/or D1,
a far-mouth microphone M2 for picking up a noise signal in addition to the near-end speaker's voice signal S2, said speaker's voice signal being at a lower level than the near-mouth microphone, said unwanted noise signal including for example background noise N2 or other speakers' voice signal D2,
an orientation sensor OS for measuring an orientation indication of said mobile device;
an audio processing unit comprising:
   a first processing unit PR1 for pre-processing the incoming signal IS,
   an adaptive beam-former BF coupled to the near-mouth and far-mouth microphones, including spatial filters for spatially filtering the input signals z1 and z2 delivered by the two microphones,
   a spectral post-processor SPP for post-processing the signal delivered by the beam-former so as to separate the desired voice signal S1 from the unwanted noise signal so as to deliver the output signal y.

The audio processing unit continuously adjusts the spatial filters, as it will be seen in more detail hereinafter.

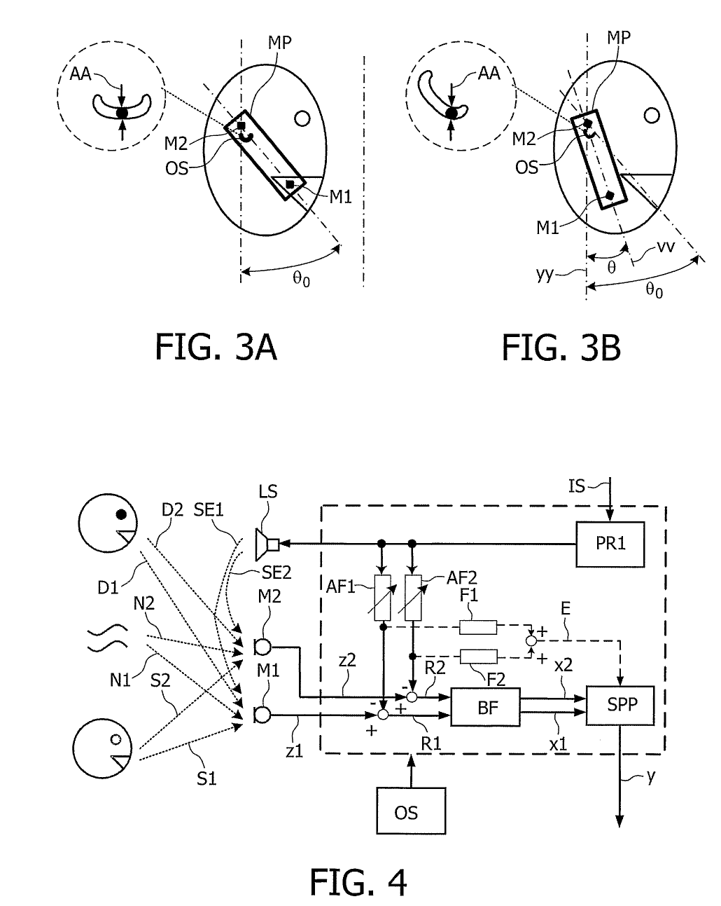

The orientation sensor gives information about the angle under which the mobile phone or headset is held against the ear. Said sensor is, for example, based on an electrically conducting metal ball in a small and curved tube. Such a sensor is illustrated in FIGS. 2A and 2B in the case of a headset, and in FIGS. 3A and 3B in the case of a mobile phone. In such cases, the orientation sensor OS and the far-mouth microphone M2 are located in the earphone. The arrows AA on the curved tube indicate the electrical contact points.

In FIG. 2A or 3A, the headset or mobile phone is orientated optimally since the near-mouth microphone M1 is closest to the mouth. In this first position, the metal ball is in the middle of the curved tube and the electrical signal delivered by the orientation sensor has a predetermined value corresponding, in our example, to an optimal angle θ₀ with respect to the vertical direction. This optima angle is determined a priori or can be tuned by the user.

In FIG. 2B or 3B, the headset or mobile phone is orientated incorrectly. This second position of the headset or mobile phone corresponds to an angle θ different from the optimal angle and to a near-mouth microphone M1 which is far from the mouth. As shown in FIG. 2B or 3B, the current angle θ is defined as the angle between the direction uu passing through the two microphones of the headset or the vertical symmetry axis vv of the mobile phone, respectively, and the vertical direction yy along the head of the user. As shown in FIG. 2A or 3A, the optimal angle θ₀ is the angle θ for which the near-mouth microphone is closest to the mouth of the user.

The value of the electrical signal delivered by the orientation sensor is changing when the metal ball is moving within the curved tube and is representative of the current angle θ of the headset or mobile phone in the vertical plane. The angle is then converted into the digital domain and then delivered to the audio processing unit.

It will be apparent to a person skilled in the art that other kinds of orientation sensors are possible provided that they are small form factor sensors. It can be, for example, a sensor based on optical detection of a moving device in the earth's gravitational field, such as the one described in the patent U.S. Pat. No. 5,142,655. The orientation sensor can also be an accelerometer, or a magnetometer.

The audio processing unit operates as follows. The signal delivered by the near-mouth microphone is called z1, and the signal delivered by the far-mouth microphone is called z2. The beam-former includes adaptive filters, one adaptive filter per microphone input. Said adaptive filters are, for example, the ones described in the international patent application WO99/27522. Such a beam-former is designed such that, after initial convergence, it provides an output signal x2 in which the stationary and non-stationary background noises picked up by the microphones are present and in which the desired voice signal S1 is blocked. The signal x2 serves as a noise reference for the spectral post-processor SPP. In the case of an N-microphone adaptive beam-former, with N>2, there are N-1 noise reference signals, which can be linearly combined to provide the spectral post-processor with the overall noise reference signal. Thanks to the use of adaptive filters, the other beam-former output signal x1 is already improved compared with the near-mouth microphone signal z1, in the sense that the signal-to-noise ratio is better for the signal x1 than for the signal z1. Alternatively, we can have x1=z1.

The spectral post-processor SPP is based on spectral subtraction techniques, as described in the prior art or in the patent U.S. Pat. No. 6,546,099. It takes as inputs the noise reference signal x2 and the improved near-mouth signal x1. The input signal samples of each of the signals x1 and x2 are Hanning windowed on a frame basis and then frequency transformed using, for example, a Fast Fourier Transform FFT. The two obtained spectra are denoted by X₁(f) and X₂(f), and their spectral magnitudes by |X₁(f)| and |X₂(f)| where f is the frequency index of the FFT result. Based on the spectral magnitude |X₁(f)|, the spectral post-processor calculates an estimate of a stationary part |N₁(f)| of the noise spectrum by spectral minimum search, as described for example in “Spectral subtraction based on minimum statistics”, by R. Martin, Signal Processing VII, Proc. EUSIPCO, Edinburgh (Scotland, UK), September 1994, pp. 1182-1185. The spectral post-processor then calculates the spectral magnitude |Y(f)| of the output signal y as follows:

$$\begin{matrix}\vert Y ( f ) \vert = G ( f ) \cdot \vert {X}_{1} ( f ) \vert \\ = max ( \frac{\vert {X}_{1} ( f ) \vert - {γ}_{2} χ ( f ) C ( f ) \vert {X}_{2} ( f ) \vert - {γ}_{1} \vert {N}_{1} ( f ) \vert}{\vert {X}_{1} ( f ) \vert} , {G}_{min 0} ) \cdot \\ \vert {X}_{1} ( f ) \vert\end{matrix} \qquad ( 1 )$$

where G(f) is the real-value of a spectral attenuation function with 0≦G(f)≦1.

In Equation (1) it is ensured that, for all frequencies f, the attenuation function G(f) is never smaller than a fixed threshold Gₘᵢₙ₀ with 0≦Gₘᵢₙ₀≦1. Typically, the threshold Gₘᵢₙ₀ is in the range between 0.1 and 0.3.

The coefficients γ₁ and γ₂ are the so-called over-subtraction parameters (with typical values between 1 and 3), γ₁ being the over-subtraction parameter for the stationary noise, and γ₂ being the over-subtraction parameter for the non-stationary noise.

The term C(f) is a frequency-dependent coherence term. In order to calculate the term C(f), an additional spectral minimum search is performed on the spectral magnitude |X₂(f)| yielding the stationary part |N₂(f)|. The term C(f) is then estimated as the ratio of the stationary parts of |X₁(f)| and |X₂(f)| C(f)=|N₁(f)|/|N₂(f)|. It is assumed here that the same relation holds for the non-stationary parts, which is a valid assumption for diffuse sound field noises.

The term C(f)|X₂(f)| in Equation (1) reflects the additive noise in |X₁(f)|. The term χ(f) is a frequency-dependent correction term that selects from the term C(f)|X₂(f)| only the non-stationary part, so that the stationary noise is subtracted only once, namely only with the spectral magnitude |N₁(f)| in Equation (1). The term χ(f) is computed as follows:

$$χ ( f ) = \frac{\vert {X}_{2} ( f ) \vert - \vert {N}_{2} ( f ) \vert}{\vert {X}_{2} ( f ) \vert} \qquad ( 2 )$$

Alternatively, for sake of simplicity, one can set γ₁ to 0 so that the calculation of the spectral magnitude |N₁(f)| is avoided, and χ(f) to 1. In this way, both stationary and non-stationary noise components are suppressed at the same time with a unique over subtraction parameter γ₂:

$$\vert Y ( f ) \vert = max ( \frac{\vert {X}_{1} ( f ) \vert - {γ}_{2} C ( f ) \vert {X}_{2} ( f ) \vert}{\vert {X}_{1} ( f ) \vert} , {G}_{min 0} ) \cdot \vert {X}_{1} ( f ) \vert \qquad ( 3 )$$

A reason to compute the spectral magnitude |Y(f)| in accordance with Equation (1) is to have a different over-subtraction parameter for the stationary noise part and for the non-stationary noise part.

For the phase of the output spectrum Y(f), the unaltered phase of the signal x1 is taken. Finally, the time-domain output signal y with improved SNR is constructed from its spectrum Y(f) using a well-known overlapped reconstruction algorithm, as described for example in “Suppression of Acoustic Noise in Speech using Spectral Subtraction”, by S. F. Boll, IEEE Trans. Acoustics, Speech and Signal Processing, vol. 27, pp. 113-120, April 1979.

According to a first embodiment of the invention, the audio processing unit comprises means for detecting an in-beam activity. The coefficients of the beam-former adaptive filters are updated when the so-called in-beam activity is detected. This means that the near-end speaker is active and talking in the beam that is made up by the combined system of microphones and adaptive beam-former. An in-beam activity is detected when the following conditions are met:
P_{z1}>αP_{z2} (c1)
Pₓ₁>βCPₓ₂ (c2)

where:
P_{z1} and P_{z2} are the short-term powers of the two respective microphone signals z1 and z2,
α is a positive constant (typically 1.6) and β is another positive constant (typically 2.0),
Pₓ₁ and Pₓ₂ are the short-term powers of the signals x1 and x2, respectively, and
C is a coherence term. This coherence term is estimated as the short-term full-band power of the stationary noise component N1 in x1 divided by the short-term full-band power of the stationary noise component N2 in x2.

The first condition (c1) reflects the voice level difference between the two microphones that can be expected from the difference in distances between the microphones and the user's mouth. The second condition (c2) requires that the desired voice signal in x1 exceeds the unwanted noise signal to a sufficient extent.

For an incorrect orientation, the power P_{z1} is much smaller than for a correct orientation and, taking into account the two in-beam conditions (c1) and (c2), the desired voice signal S1 is detected as ‘out of the beam’. Without any extra measures the system cannot recover because the beam-former coefficients are not allowed to adapt. With incorrect beam-former coefficients the signal x2 has a relatively strong component due to the desired voice signal, and said voice component is subtracted in accordance with the spectral calculation of Equation (1). Consequently the desired voice signal is attenuated or even completely suppressed at the output of the post-processor.

As described before, the orientation sensor provides the audio processing unit with an orientation indication. In this first embodiment, the orientation of the headset or mobile phone is said to be incorrect if the current angle θ measured by the orientation sensor differs from the optimal angle θ₀ from more than a predetermined value, let's say for example 5 degrees. When an incorrect orientation of the mobile phone or headset is detected, the following steps are taken. The coefficients α and β are temporarily lowered or even set to 0 such that the beam-former is allowed to re-adapt.

Alternatively, or in addition, the following fall back mechanism is applied. When an incorrect orientation is detected, the signal x2 is set to 0 or the coefficient γ₂ is temporarily lowered or even set to 0 in order to prevent undesired subtraction of speech. In this case the dual-microphone noise reduction method reduces to a single-microphone noise suppression method, and only an estimated stationary noise component |N₁(f)| is subtracted from the input spectral magnitude |X₁(f)| instead of the non-stationary noise component.

After a predetermined time corresponding to the time necessary for re-adaptation, the coefficients α and β are increased again towards their original values or to values that are off-line determined to be optimal for the particular new orientation. Similarly, the coefficient γ₂ is also be set back to its original value.

According to a second embodiment of the invention, noise suppression is performed gradually, the degree of noise suppression depending on the orientation angle of the telephony device.

This embodiment is based on the observation according to which the signal-to-noise ratio gradually decreases when the absolute difference between the current angle θ and the optimal angle θ₀ gradually increases. With a decreasing signal-to-noise ratio (i.e. below 10 dB where speech distortion would become disturbing), an increasing limitation of the amount of spectral noise suppression is desired in order to prevent unacceptable speech distortion.

According to this embodiment of the invention, the term Gₘᵢₙ₀ of Equation (1) is modified in order to achieve a dependency of the attenuation function as a function of the current angle θ measured by the orientation sensor. The spectral post-processor then calculates the spectral magnitude |Y(f)| of the output signal y as follows:

$$\begin{matrix}\vert Y ( f ) \vert = G ( f ) \cdot \vert {X}_{1} ( f ) \vert \\ = max ( \frac{\vert {X}_{1} ( f ) \vert - {γ}_{2} χ ( f ) C ( f ) \vert {X}_{2} ( f ) \vert - {γ}_{1} \vert {N}_{1} ( f ) \vert}{\vert {X}_{1} ( f ) \vert} , {G}_{min} ( θ ; {θ}_{0} ) ) \cdot \\ \vert {X}_{1} ( f ) \vert\end{matrix} \qquad ( 4 )$$

where Gₘᵢₙ(θ;θ₀) is given by:
   Gₘᵢₙ(θ;θ₀)=max(Gₘᵢₙ₀, sin(|θ−θ₀|)) (5)
   where |θ−θ₀| is the absolute value of θ−θ₀.

Thanks to this modification, the noise suppression method works in a conventional way when the mobile phone is held at an angle not too far from the optimal angle. More specifically, when |θ−θ₀|≦ε with ε=arcsin(Gₘᵢₙ₀), Equation (5) achieves Gₘᵢₙ(θ;θ₀)=Gₘᵢₙ₀, and Equation (4) reduces to Equation (1).

On the contrary, as soon as the mobile phone or headset is held at a larger angle, the amount of noise suppression is automatically decreased in order to prevent disturbing speech distortion. More specifically, when |θ−θ₀|>ε, then Gₘᵢₙ(θ;θ₀)=sin(|θ−θ₀|) and Gₘᵢₙ(θ;θ₀)>Gₘᵢₙ₀, so that less suppression of the noise is obtained with Equation (4) than with Equation (1), thus avoiding disturbing speech distortion.

The second embodiment can be improved by controlling the adaptation of the beam-former coefficients with an in-beam detector. Adaptation is halted when no in-beam activity is detected, and adaptation continues otherwise. By this measure false beam-former adaptation on unwanted noise signal is prevented.

An in-beam activity is detected when the following conditions are met:
P_{z1}(n)>α(θ)P_{z2}(n) (c3)
Pₓ₁(n)>β(θ,n)C(n)Pₓ₂(n) (c4)

If the conditions (c3) and (c4) are fulfilled, the beam-former coefficients are allowed to adapt. As before, P_{z1}(n) and P_{z2}(n) are the short-term powers of the two respective microphone signals, Pₓ₁(n) and Pₓ₂(n) are the short-term powers of the signals x₁ and x₂, respectively, and n is an integer iteration index increasing with time, and C(n) Pₓ₂(n) is the estimated short-term power of the (non-)stationary noise in x₁ with C(n) a coherence term.

Condition (c3) reflects the speech level difference between the two microphones that can be expected from the difference in distances between the microphones and the user's mouth. Condition (c4) requires that the desired voice signal in x1 exceeds the unwanted noise signal to a sufficient extent.

In addition, the parameter α is depending on the current angle θ as follows:
α(θ)=α₀*cos(|θ−θ₀|), α₀>0 (6)
where α₀ a positive constant (typically α₀=1.6). Thanks to the dependency of α on the angle as defined in Equation (6), the beam-former adaptation is not blocked when someone changes the orientation of the mobile phone away from the optimal orientation where the speech level difference between the two microphones is expected to be lower.

Similarly, the parameter β is depending on the current angle θ as follows:
β(θ,n)=β₀*cos(Δθ(n)), β₀>0 (7)
where β₀ a positive constant (typically β₀=1.6). The term Δθ(n) is given by

$$Δ θ ( n ) = \{ \begin{matrix}\vert θ ( n ) - θ ( n - 1 ) \vert & when \vert θ ( n ) - θ ( n - 1 ) \vert > δ \\ λ Δ θ ( n - 1 ) & otherwise .\end{matrix} \qquad ( 8 )$$

Initially, Δθ(0)=0. δ is a positive constant, for example δ=π/20, and λ is a constant ‘forgetting factor’ such that 0λ<1. Usually λ is chosen close to 1. Using the mechanism described in Equations (7) and (8), the term β(θ,n) is quickly lowered when a sudden large orientation change occurs, and, after such a quick orientation change, β(θ,n) is slowly increased towards β₀ again.

This behavior can be explained as follows. A sudden orientation change of the telephony device results in a sudden increase in the power Pₓ₂(n) because the beam-former coefficients are no longer optimal and the noise reference signal x2 erroneously contains a near-end speech component. If the parameter β is unchanged, then the adaptation of the beam-former is stopped based on condition (c3), whereas a re-adaptation to the new orientation is desired. By making β(θ,n) small during a sudden orientation change the beam-former adaptation is no longer blocked by condition (c3) and therefore has the opportunity to re-adapt. After a predetermined time, the beam-former has re-adapted and β₀ is again the best value for β(θ,n).

Turning to FIG. 4, an acoustic echo cancellation scheme combined with a dual-microphone beam-forming is depicted. According to this scheme, the telephony device further comprises two adaptive filters AF1 and AF2, which have at their outputs estimates of the echo signals SE1 and SE2. Next these estimated echo's are subtracted from the microphone signals z1 and z2, yielding the echo residual signals R1 and R2, respectively. The echo residual signals are then fed to the input ports of the adaptive beam-former BF. In this way the beam-former inputs are (almost) cleaned of acoustic echo's and can operate as if there were no echo.

In order to improve acoustic echo suppression the spectral post-processor SPP receives an additional input E as a reference of the acoustic echo for spectral echo subtraction. This is indicated by the dashed lines in FIG. 4. The outputs of the adaptive filters AF1 and AF2 are filtered with filters F1 and F2 respectively and the result is summed yielding the echo reference signal E. The coefficients of the filters F1 and F2 are directly copied from the adaptive beam-former BF coefficients.

Taking into account the additional input E, the spectral post-processor then calculates the spectral magnitude |Y(f)| of the output signal y as follows:

$$\begin{matrix}\vert Y ( f ) \vert = G ( f ) \cdot \vert {X}_{1} ( f ) \vert \\ = max ( \begin{matrix}\frac{\vert {X}_{1} ( f ) \vert - {γ}_{2} χ ( f ) C ( f ) \vert {X}_{2} ( f ) \vert - {γ}_{1} \vert {N}_{1} ( f ) \vert - {γ}_{e} \vert E ( f ) \vert}{\vert {X}_{1} ( f ) \vert} , \\ {G}_{min 0}\end{matrix} ) \cdot \\ \vert {X}_{1} ( f ) \vert\end{matrix} \qquad ( 9 )$$

where γₑ is the spectral subtraction parameter for the echo signal (0<γₑ<1) and E(f) is the short-term spectrum of the echo reference signal E.

The above description is based on the use of an orientation sensor in a mobile phone or headset equipped with at least two microphones. However, the orientation sensor can also applied to a mobile phone or headset equipped with only a single microphone.

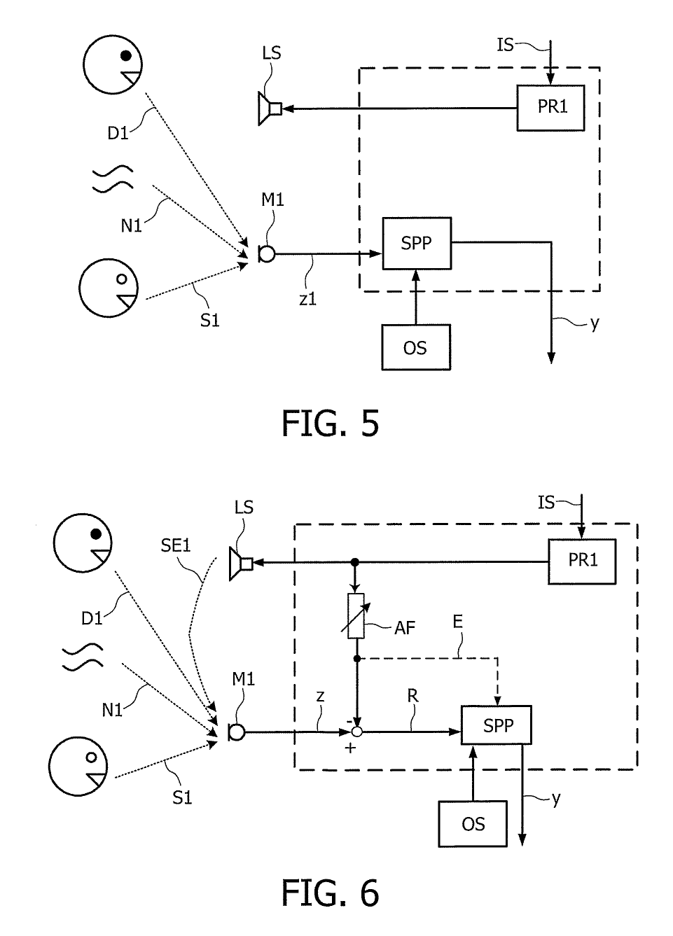

Referring to FIG. 5, such a single microphone device is depicted. Compared to FIG. 1, it consists in disconnecting the secondary microphone, resulting in x₂=0 and x₁=z₁ in Equation (4). The telephony device no longer contains the adaptive beam-former.

In such a case, the spectral post-processor calculates the spectral magnitude |Y(f)| of the output signal y as follows:

$$\begin{matrix}\vert Y ( f ) \vert = G ( f ) \cdot \vert {Z}_{1} ( f ) \vert \\ = max ( \frac{\vert {Z}_{1} ( f ) \vert - {γ}_{1} \vert {N}_{1} ( f ) \vert}{\vert {Z}_{1} ( f ) \vert} , {G}_{min} ( θ ; {θ}_{0} ) ) \cdot \\ \vert {Z}_{1} ( f ) \vert\end{matrix} \qquad ( 10 )$$

where Gₘᵢₙ(θ;θ₀) is defined according to Equation (5).

Turning to FIG. 6, an acoustic echo cancellation scheme combined with a single-microphone beam-forming is depicted. According to this scheme, the telephony device comprises an adaptive filter AF, which has at its output an estimate of the echo signal SE1. Next this estimated echo signal is subtracted from the microphone signal z, yielding the echo residual signal R. The echo residual signal is then fed to the spectral post-processor SPP.

In order to improve acoustic echo suppression, the spectral post-processor SPP receives an additional input E as a reference of the acoustic echo for spectral echo subtraction. The echo reference signal E is the output of the adaptive filter AF.

Taking into account the additional input E, the spectral post-processor then calculates the spectral magnitude |Y(f)| of the output signal y as follows:

$$\begin{matrix}\vert Y ( f ) \vert = G ( f ) \cdot \vert {Z}_{1} ( f ) \vert \\ = max ( \frac{\vert {Z}_{1} ( f ) \vert - {γ}_{1} \vert {N}_{1} ( f ) \vert - {γ}_{e} \vert E ( f ) \vert}{\vert {Z}_{1} ( f ) \vert} , {G}_{min} ( θ ; {θ}_{0} ) ) \cdot \\ \vert {Z}_{1} ( f ) \vert\end{matrix} \qquad ( 11 )$$

where γₑ is the spectral subtraction parameter for the echo signal (0<γ₃<1) and E(f) is the short-term spectrum of the echo reference signal E.

Several embodiments of the present invention have been described above by way of examples only, and it will be apparent to a person skilled in the art that modifications and variations can be made to the described embodiments without departing from the scope of the invention as defined by the appended claims. Further, in the claims, any reference signs placed between parentheses shall not be construed as limiting the claim. The term “comprising” does not exclude the presence of elements or steps other than those listed in a claim. The terms “a” or “an” does not exclude a plurality. The invention can be implemented by means of hardware comprising several distinct elements, and by means of a suitably programmed computer. In a device claim enumerating several means, several of these means can be embodied by one and the same item of hardware. The mere fact that measures are recited in mutually different independent claims does not indicate that a combination of these measures cannot be used to advantage.

1. A telephony device comprising:
an orientation sensor (OS) for measuring an orientation indication of said telephony device,
at least one microphone (M1) for receiving an acoustic signal including a desired voice signal and an unwanted noise signal,
an audio processing unit coupled to the at least one microphone for suppressing the unwanted noise signal from the acoustic signal on the basis of the orientation indication.

2. A telephony device as claimed in claim 1, comprising:
a near-mouth microphone (M1) for receiving an acoustic signal including the desired voice signal (S1) and the unwanted noise signal (N1,D1), and for delivering a first input signal (z1),
a far-mouth microphone (M2) for receiving an acoustic signal including the unwanted noise signal (N2,D2) and the desired voice signal (S2) at a lower level than the near-mouth microphone and for delivering a second input signal (z2),
and wherein the audio processing unit includes:
a beam-former (BF) coupled to the near-mouth and far-mouth microphones, comprising filters for spatially filtering the first and second input signals (z1,z2) so as to deliver a noise reference signal (x2) and an improved near-mouth signal (x1),
a spectral post-processor (PP) for performing spectral subtraction of the signals (x1,x2) delivered by the beam-former so as to deliver an output signal (y).

3. A telephony device as claimed in claim 2, wherein the spectral post-processor is adapted to compute a spectral magnitude of the output signal from a product of a spectral magnitude of the improved near-mouth signal by an attenuation function, said attenuation function depending on a difference between the spectral magnitude of the improved near-mouth signal, a weighted spectral magnitude of an estimate of a stationary part of said improved near-mouth signal, and a weighted spectral magnitude of the noise reference signal, the value of said attenuation function being not smaller than a threshold, said threshold being the maximum between a fixed value and a function of the orientation indication.

4. A telephony device as claimed in claim 3, wherein the threshold is the maximum between the fixed value and a sinus function of the orientation indication.

5. A telephony device as claimed in claim 1, comprising a microphone (M1) for receiving an acoustic signal including the desired voice signal (S1) and the unwanted noise signal (N1,D1) and for delivering an input signal (z1), and wherein the audio processing unit includes a spectral post-processor which is adapted to compute a spectral magnitude of an output signal (y) from a product of a spectral magnitude of the input signal by an attenuation function, said attenuation function depending on a difference between the spectral magnitude of the input signal and a weighted spectral magnitude of an estimate of a stationary part of said input signal, the value of said attenuation function being not smaller than a threshold, said threshold being the maximum between a fixed value and a function of the orientation indication.

6. A telephony device as claimed in claim 1, further comprising a loudspeaker (LS) for receiving an incoming signal and for delivering an echo signal (SE1,SE2), and means (AF;AF1,AF2,F1,F2) responsive to the incoming signal for performing echo cancellation, said means being coupled to the spectral post-processor (SPP).

7. A noise suppression method for a telephony device, comprising the steps of:
determining an orientation indication of said telephony device,
receiving via at least one microphone an acoustic signal including a desired voice signal and an unwanted noise signal,
processing the signals delivered by the at least one microphone so as to suppress the unwanted noise signal from the acoustic signal on the basis of the orientation indication.

8. A noise suppression method as claimed in claim 7, wherein the radio telephony device includes two microphones (M1,M2) for receiving the acoustic signal and for delivering a first (z1) and a second (z2) input signals, respectively, said method further comprising the step of spatially filtering the first and second input signals so as to deliver a noise reference signal (x2) and an improved near-mouth signal (x1), the step of processing being adapted to perform spectral subtraction on the signals (x1,x2) delivered by said filtering step so as to deliver an output signal (y).

9. A noise suppression method as claimed in claim 8, wherein the step of processing is adapted to compute a spectral magnitude of the output signal from a product of a spectral magnitude of the improved near-mouth signal by an attenuation function, said attenuation function depending on a difference between the spectral magnitude of the improved near-mouth signal, a weighted spectral magnitude of an estimate of a stationary part of said improved near-mouth signal, and a weighted spectral magnitude of the noise reference signal, the value of said attenuation function being not smaller than a threshold, said threshold being the maximum between a fixed value and a function of the orientation indication.
